(19) United States
(12) Patent Application Publication
(10) Pub. No.: US 2012/0120083 A1
(43) Pub. Date: May 17, 2012

(54) DISPLAY APPARATUS, AND DISPLAY CONTROLLER AND OPERATING METHOD THEREOF

(75) Inventors: Ching-Wen Kong, Hsinchu City (TW); Jung-Chieh Cheng, Hsinchu City (TW)

(73) Assignee: NOVATEK MICROELECTRONICS CORP., Hsinchu (TW)

(21) Appl. No.: 13/089,301

(22) Filed: Apr. 18, 2011

Related U.S. Application Data
(60) Provisional application No. 61/412,796, filed on Nov. 12, 2010.

(30) Foreign Application Priority Data
Jan. 28, 2011 (TW) 100103474

(51) Int. Cl. G09G 5/36

(52) U.S. Cl. 345/545

(57) ABSTRACT

A display apparatus, and a display controller and an operating method thereof are provided. The display controller includes a controller, a buffer, and a compression/decompression unit. The controller receives an original frame from a host. The controller controls a display module to display the original frame provided by the host in a non-still frame mode. The compression/decompression unit is coupled between the buffer and the controller. The controller compresses the original frame to the buffer through the compression/decompression unit. If the controller operates in a still frame mode, the controller decompresses a compressed frame in the buffer to obtain a decompressed frame through the compression/decompression unit, and controls the display module to display the decompressed frame.

### CROSS-REFERENCE TO RELATED APPLICATION

This application claims the priority benefits of U.S. provisional application Ser. No. 61/412,796, filed on Nov. 12, 2010 and Taiwan application serial no. 100103474, filed on Jan. 28, 2011. The entirety of each of the above-mentioned patent applications is hereby incorporated by reference herein and made a part of this specification.

### BACKGROUND OF THE INVENTION

1. Field of the Invention

The present invention generally relates to a display apparatus, in particular, to a display controller.

2. Description of Related Art

FIG. 1 is a schematic functional block diagram of a conventional display apparatus. Referring to FIG. 1, an electronic system 100 includes a host 110 and a display apparatus 120. Depending on different application systems, the host 110 may be various types of processors, controllers, or computers. For example, if the electronic system 100 is applied in a mobile phone system, the host 110 may be a baseband processor. If the electronic system 100 is applied in a monitor system, the host 110 may be a monitor controller. If the electronic system 100 is applied in a notebook computer system, the host 110 may be a display processor or a graphics processing unit (GPU).

The display apparatus 120 includes a controller 130 and a display module 140. The display module 140 includes a gate driver 141, a source driver 142, and a display panel 143. The host 110 transmits display data D to the controller 130, such that the host 110 can output a sequence of original frames to the controller 130 at a frequency of 60 Hz or 75 Hz. As the host 110 periodically and continuously provides a sequence of original frames to the controller 130, the controller 130 can display the original frames on the display panel 143 through the source driver 142, without temporarily storing the original frames provided by the host 110. That is to say, no matter whether the original frames provided by the host 110 are still frames, the display data D needs to be continuously transmitted between the controller 130 and the host 110. However, when the original frames provided by the host 110 are still frames, namely, the sequence of original frames provided by the host 110 is the same display data, the original frames having the same display data are still continuously and repeatedly transmitted between the controller 130 and the host 110. Obviously, the continuous and repeated transmission of the original frames having the same display data between the controller 130 and the host 110 is redundant and very power consuming.

### SUMMARY OF THE INVENTION

Accordingly, the present invention is directed to a display apparatus, and a display controller and an operating method thereof. When an original frame provided by a host is a still frame, the display apparatus may perform self refresh. When the display apparatus performs self refresh, display data does not need to be transmitted between a controller and the host, so as to lower power consumption.

In an embodiment, the present invention provides a display controller, which includes a controller, a buffer, and a compression/decompression unit. The controller receives an original frame from a host. The controller controls a display module to display the original frame provided by the host in a non-still frame mode. The compression/decompression unit is coupled between the buffer and the controller. The controller compresses the original frame to the buffer through the compression/decompression unit. If the controller operates in a still frame mode, the controller decompresses a compressed frame in the buffer to obtain a decompressed frame through the compression/decompression unit, and controls the display module to display the decompressed frame.

In an embodiment, the present invention provides an operating method of a display controller, which includes: receiving an original frame from a host; compressing the original frame to obtain a compressed frame; storing the compressed frame in a buffer; in case of a non-still frame mode, controlling a display module to display the original frame provided by the host; and in case of a still frame mode, decompressing the compressed frame to obtain a decompressed frame, and controlling the display module to display the decompressed frame.

In an embodiment, the present invention provides a display apparatus, which includes a display module, a controller, a buffer, and a compression/decompression unit. The controller is connected to the display module, and receives an original frame from a host. The controller controls the display module to display the original frame provided by the host in a non-still frame mode. The compression/decompression unit is coupled between the buffer and the controller. The controller compresses the original frame to the buffer through the compression/decompression unit. If the controller operates in a still frame mode, the controller decompresses a compressed frame in the buffer to obtain a decompressed frame through the compression/decompression unit, and controls the display module to display the decompressed frame.

In view of the above, the host according to the embodiments of the present invention can determine whether a current original frame is a still frame. When the current original frame is a still frame, the host can trigger the controller of the display apparatus to enter the still frame mode, so as to compress the original frame to the buffer, and thus a buffer having a capacity smaller than a data volume of the original frame can be used in the present invention for lowering the hardware cost. After the original frame is successfully compressed to the buffer, transmission of display data between the controller and the host may be stopped. In this case, the display apparatus can perform self refresh, namely, the controller decompresses the compressed frame in the buffer to obtain a decompressed frame through the compression/decompression unit, and controls the display module to display the decompressed frame. When the display apparatus performs self refresh, the display data does not need to be transmitted between the controller and the host, and thus the display apparatus and the display controller according to the embodiments of the present invention can lower power consumption.

In order to make the aforementioned features and advantages of the present invention more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic functional block diagram of a conventional display apparatus.

FIG. 2 is a schematic functional block diagram of a display apparatus according to an embodiment.

FIG. 3 is a schematic functional block diagram of a display apparatus according to an embodiment of the present invention.

FIG. 4 is a schematic diagram of an operating method of an electronic system in FIG. 3 according to an embodiment of the present invention.

FIG. 5 is a schematic functional block diagram of an electronic system according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

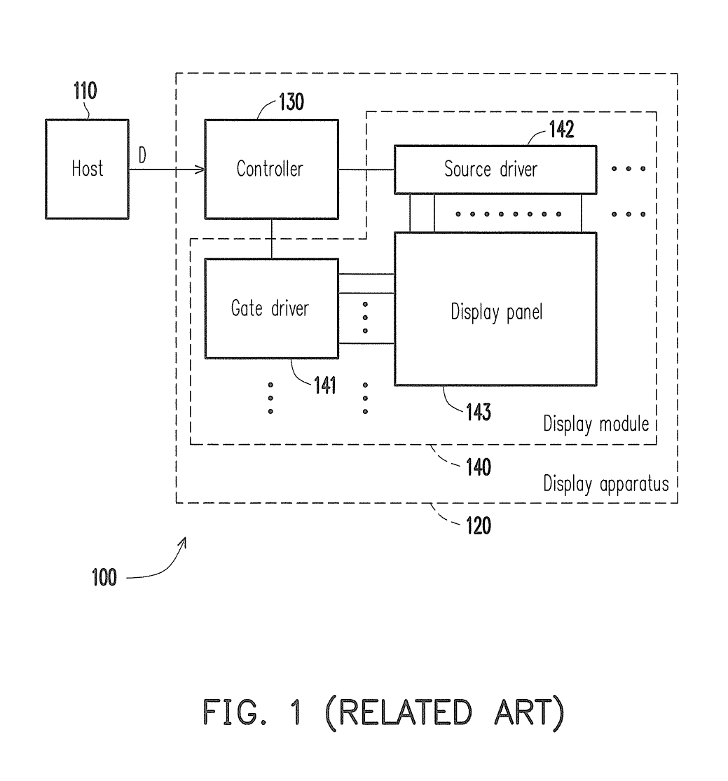

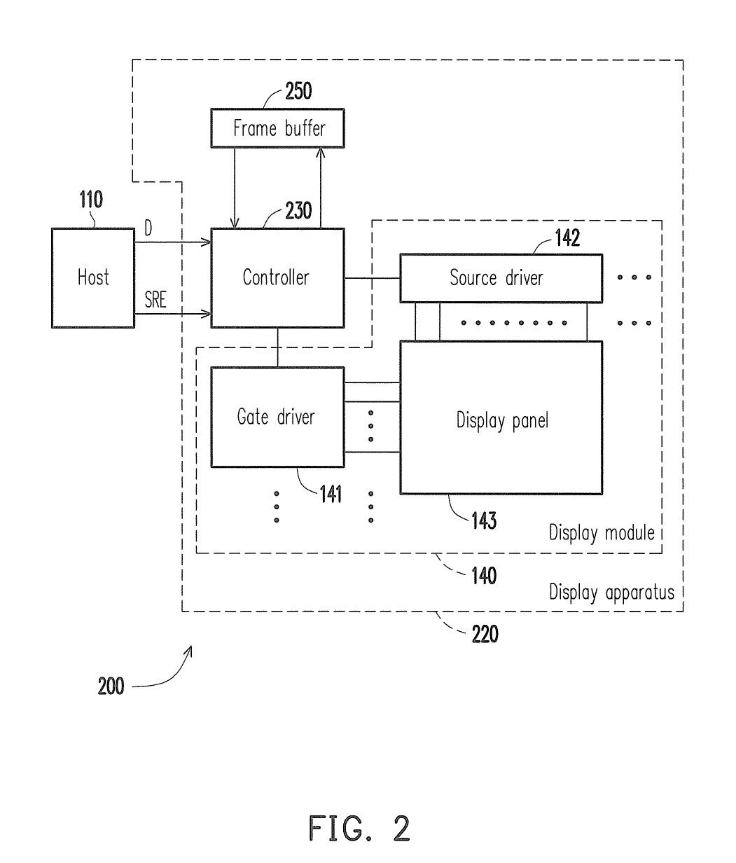

FIG. 2 is a schematic functional block diagram of a display apparatus according to an embodiment. Referring to FIG. 2, an electronic system 200 includes a host 110 and a display apparatus 220. The implementation of the host 110 may be found in the related description of FIG. 1. The display apparatus 220 includes a display module 140 and a display controller, in which the display controller includes a controller 230 and a frame buffer 250. The display module 140 includes a gate driver 141, a source driver 142, and a display panel 143. Display data D is transmitted to the controller 230, such that the host 110 can output a sequence of original frames to the controller 230 at a frequency of 60 Hz, 75 Hz, or the like.

The host 110 performs motion detection to determine whether a currently provided original frame is a still frame, and outputs a self refresh enable signal SRE to the controller 230 according to a result of the motion detection. The controller 230 decides to operate in a “non-still frame mode” or a “still frame mode” according to the self refresh enable signal SRE. If the result of the motion detection indicates that the currently provided original frame is not a still frame, the self refresh enable signal SRE is in a disable state (for example, at a low logic level), such that the controller 230 operates in the “non-still frame mode”. In the non-still frame mode, the host 110 periodically and continuously provides a sequence of original frames to the controller 230 through the transmission of the display data D. The controller 230 can display the original frames provided by the host 110 on the display panel 143 through the source driver 142.

If the result of the motion detection performed by the host 110 indicates that the currently provided original frame is a still frame, the self refresh enable signal SRE is in an enable state (for example, at a high logic level), such that the controller 230 operates in the “still frame mode”. In the still frame mode, the host 110 stores the original frame in the frame buffer 250 through the controller 230 by means of memory addressing. A capacity of the frame buffer 250 must be equal to or larger than a data volume of the original frame, so as to store the whole original frame. After the original frame is stored in the frame buffer 250, the transmission of the display data D between the controller 230 and the host 110 may be stopped. In this case, the display apparatus 220 can perform self refresh, namely, the controller 230 obtains the original frame from the frame buffer 250, and controls the display module 140 to display the original frame provided by the frame buffer 250.

When the display apparatus 220 performs self refresh, the transmission of the display data D between the controller 230 and the host 110 may be stopped, and thus the electronic system 200 and the display apparatus 220 according to this embodiment can lower power consumption. Compared with FIG. 1, the display apparatus 220 in the embodiment shown in FIG. 2 needs to be provided with a frame buffer 250 sufficient to store a whole original frame. With the improvement of the frame resolution, the capacity of the frame buffer 250 should be correspondingly increased. For example, if the frame resolution of the original frame is 1920×1080 pixels, and each pixel has three sub-pixel data of 8 bits, the capacity of the frame buffer 250 is at least 1920×1080×3×8 bit=48600 Kbit.

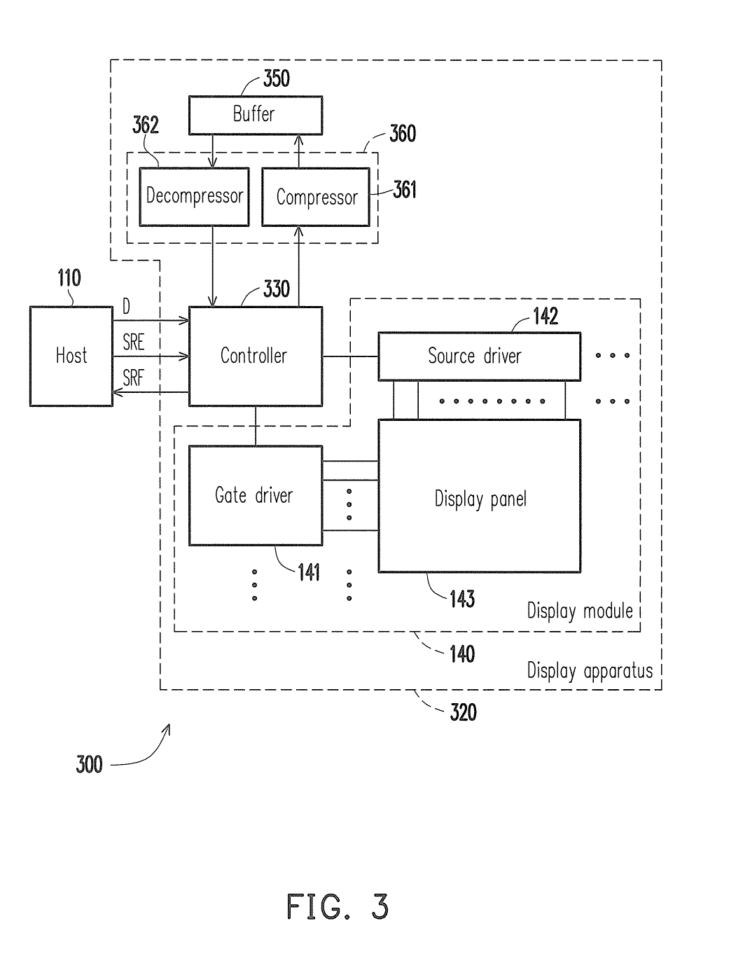

FIG. 3 is a schematic functional block diagram of a display apparatus according to an embodiment of the present invention. Referring to FIG. 3, an electronic system 300 includes a host 110 and a display apparatus 320. The implementation of the host 110 may be found in the related description of FIG. 1. The display apparatus 320 includes a display module 140 and a display controller, in which the display controller includes a controller 330, a buffer 350, and a compression/decompression unit 360. The display module 140 may be any type of display panel and driving circuit. For example, the display module 140 includes a gate driver 141, a source driver 142, and a display panel 143. The display module 140 may be well known in the art, and thus the operation details thereof are not described herein again.

The controller 330 may include a timing controller and/or a scaler of the display apparatus 320. Display data D is transmitted to the controller 330, such that the host 110 can output a sequence of original frames to the controller 330. In the case that the original frame is a non-still frame, the controller 330 may display the original frames provided by the host 110 on the display panel 143 through the source driver 142.

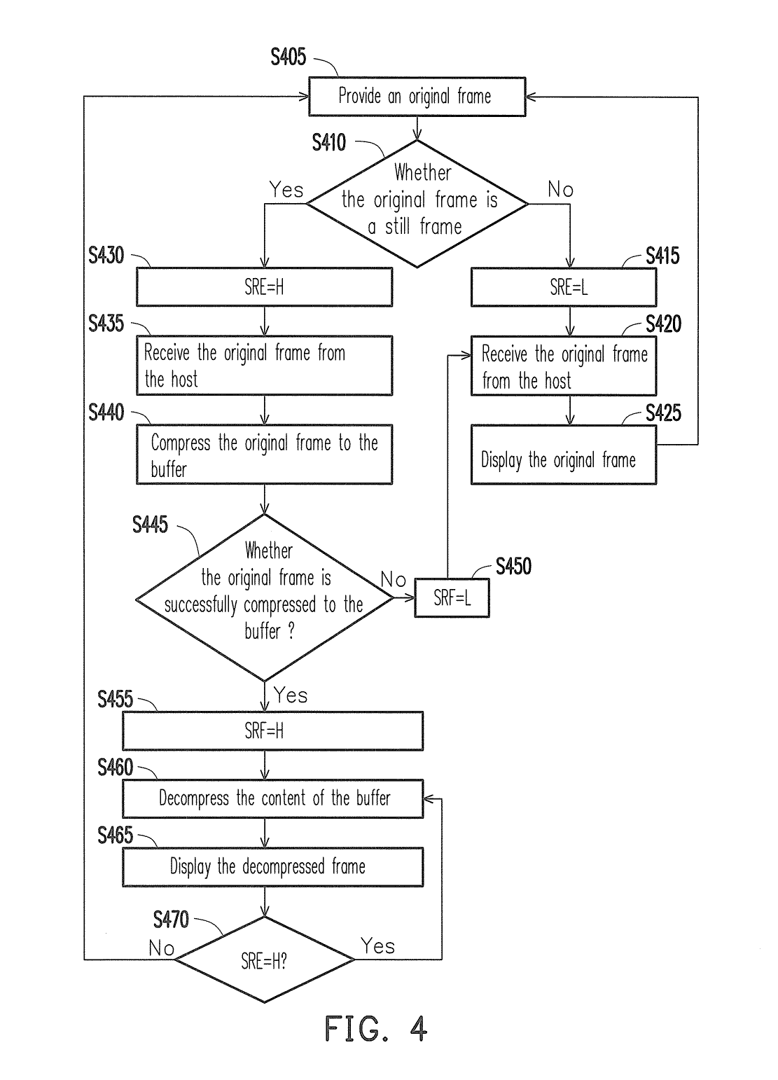

FIG. 4 is a schematic diagram of an operating method of the electronic system 300 in FIG. 3 according to an embodiment of the present invention. Referring to FIGS. 3 and 4, the host 110 may provide an original frame to be transferred to the controller 330 (Step S405). The host 110 performs motion detection on the current original frame, so as to determine whether the currently provided original frame is a still frame (Step S410), and outputs a self refresh enable signal SRE to the controller 330 according to a result of the motion detection. The controller 330 of the display apparatus 320 decides to operate in a “non-still frame mode” or a “still frame mode” according to the self refresh enable signal SRE.

If the result of the motion detection indicates that the currently provided original frame is not a still frame, the host 110 performs Step 415 to set the self refresh enable signal SRE to a disable state (for example, to a low logic level “L”), such that the controller 330 operates in the “non-still frame mode”. In the non-still frame mode, the host 110 periodically and continuously provides a sequence of original frames to the controller 330 of the display apparatus 320 through the transmission of the display data D. The controller 330 operating in the non-still frame mode receives the original frame from the host 110 (Step S420), and then controls the display module 140 to display the original frame provided by the host 110 (Step S425). At the same time when the display apparatus 320 performs Step S425, the host 110 may perform Steps S405 and S410, so as to be ready for transferring another original frame to the controller 330 of the display apparatus 320.

If the result of the motion detection performed by the host 110 indicates that the currently provided original frame is a still frame, the host 110 performs Step 430 to set the self refresh enable signal SRE to an enable state (for example, to a high logic level “H”), such that the controller 330 of the display apparatus 320 operates in the “still frame mode”. In the still frame mode, the host 110 provides the current original frame to the controller 330 of the display apparatus 320 through the transmission of the display data D. The controller 330 receives the original frame from the host 110 (Step S435), and then transfers the original frame to the compression/decompression unit 360. In this embodiment, the compression/decompression unit 360 includes a compressor 361 and a decompressor 362. Both the compressor 361 and the decompressor 362 are connected between the buffer 350 and the controller 330.

The compressor 361 of the compression/decompression unit 360 performs Step S440, so as to compress the original frame provided by the controller 330 to obtain a compressed frame, and store the compressed frame in the buffer 350. A compression method used by the compression/decompression unit 360 may be any type of lossless compression algorithm. As the original frame is stored in the buffer 350 only after compression, a capacity of the buffer 350 may be smaller than a data volume of the original frame. For example, the capacity of the buffer 350 may be 80% or 50% of the data volume of the original frame. Compared with the frame buffer 250 in FIG. 2, the display apparatus 320 may employ a buffer 350 with a smaller capacity, thereby lowering the cost.

Herein, it is assumed that the capacity of the buffer 350 is 80% of the data volume of the original frame. During the compression of the original frame to the buffer 350 by the controller 330 through the compression/decompression unit 360, the controller 330 may know whether the size of the compressed frame exceeds the capacity of the buffer 350, namely, the controller 330 may determine whether the compression/decompression unit 360 can successfully compress the original frame to the buffer 350 (Step S445). If the size of the compressed frame exceeds the capacity of the buffer 350, or the compression/decompression unit 360 cannot compress the original frame to the buffer 350, the controller 330 sets a self refresh flag SRF to a disable state (for example, to a low logic level “L”) (Step S450).

In the case that the display apparatus 320 cannot compress the original frame to the buffer 350, the controller 330 ends the still frame mode and switches to the non-still frame mode, so as to control the display module 140 to display the original frame provided by the host 110, and receive a next original frame from the host 110. Moreover, as the self refresh flag SRF is in the disable state, the host 110 continues to transfer the next original frame to the display apparatus 320.

After Step S450 is completed, the controller 330 of the display apparatus 320 performs Steps S420 and S425 again, so as to control the display module 140 to display the original frame provided by the host 110. Meanwhile, the host 110 may know that the display apparatus 320 cannot compress the current original frame to the buffer 350 by detecting the self refresh flag SRF, and thus the host 110 performs Steps S405 and S410 again to continue to transfer the next original frame to the display apparatus 320, until the self refresh enable signal SRE and the self refresh flag SRF are both in the enable state.

If the size of the compressed frame does not exceed the capacity of the buffer 350, the compression/decompression unit 360 can successfully compress the original frame to the buffer 350. Therefore, the controller 330 performs Step S455, so as to set the self refresh flag SRF to the enable state (for example, to a high logic level “H”). The host 110 may know that the display apparatus 320 has compressed the current original frame to the buffer 350 by detecting the self refresh flag SRF, and thus the host 110 stops the transmission of the display data D to the display apparatus 320. That is to say, when the controller 330 of the display apparatus 320 operates in the still frame mode, the transmission of the display data D between the controller 330 and the host 110 is stopped after the compression/decompression unit 360 successfully compresses the original frame to the buffer 350.

After Step S455 is completed, the controller 330 operating in the still frame mode performs Step S460, so as to decompress the compressed frame in the buffer 350 through the decompressor 362 of the compression/decompression unit 360, and thus the controller 330 may obtain a decompressed frame from the buffer 350. In other embodiments, after Step S455 is completed, the controller 330 performs Step S460 only after waiting for a time period of one frame. As the compression/decompression unit 360 uses lossless compression, the content of the decompressed frame obtained from the buffer 350 is in agreement with the content of the original frame provided by the host 110. Subsequently, the controller 330 performs Step S465, so as to control the display module 140 to display the decompressed frame obtained from the buffer 350.

After the display of one frame is completed, the controller 330 of the display apparatus 320 checks the state of the self refresh enable signal SRE (Step S470). If the state of the self refresh enable signal SRE is an enable state (for example, set to a high logic level “H”), the controller 330 performs Steps S460 and S465 again. If the state of the self refresh enable signal SRE is a disable state (for example, set to a high logic level “L”), it indicates that the host 110 detects that the next original frame is not a still frame. Then, the controller 330 ends the still frame mode and switches to the non-still frame mode, so as to receive the next original frame from the host 110, and control the display module 140 to display the original frame provided by the host 110.

In the embodiment shown in FIG. 4, the controller 330 does not compress the original frame to the buffer 350 when the self refresh enable signal SRE is in the disable state. In other embodiments, the controller 330 may compress the original frame provided by the host 110 to the buffer 350, and notify the host 110 of the compression result through the self refresh flag SRF, when the self refresh enable signal SRE is in the enable state. Therefore, in the case that the display apparatus 320 has successfully compressed the original frame to the buffer 350, the host 110 not only sets the self refresh enable signal SRE to the enable state, but also stops the transmission of the display data D to the controller 330, when the host 110 determines that the currently provided original frame is a still frame. For the display apparatus 320, as the controller 330 has successfully compressed the original frame to the buffer 350 before the state of the self refresh enable signal SRE is changed to the enable state, the controller 330 can immediately perform self refresh when the state of the self refresh enable signal SRE is changed to the enable state (for example, Steps S460 and S465 shown in FIG. 4).

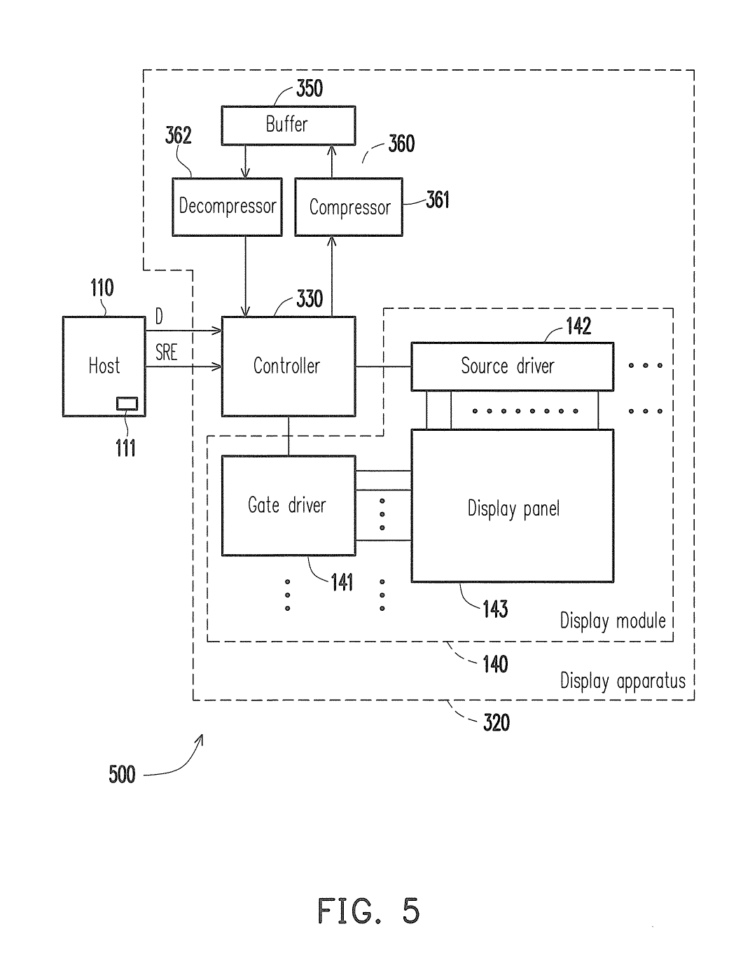

FIG. 5 is a schematic functional block diagram of an electronic system according to another embodiment of the present invention. Referring to FIG. 5, an electronic system 500 includes a host 110 and a display apparatus 320. The implementation of the embodiment shown in FIG. 5 may be found in the related description of FIG. 3. Different from the electronic system 300, the host 110 of the electronic system 500 includes a compression/decompression unit 111. The compression/decompression unit 111 can perform the same compression operation as that of the compression/decompression unit 360. If the host 110 performs motion detection and determines that the original frame is a still frame, the host 110 performs the same compression operation as that of the compression/decompression unit 360 by using the compression/decompression unit 111, so as to test a compression rate of the original frame. That is to say, the host 110 can pre-estimate whether the compression/decompression unit 360 can successfully compress the original frame to the buffer 350 before transferring the current original frame to the display apparatus 320. Therefore, the controller 330 does not need to notify the host 110 of the compression result through the self refresh flag SRF shown in FIG. 3.

After the test of the compression rate of the original frame is completed, the host 110 outputs a self refresh enable signal SRE to the controller 330 according to the compression rate. The controller 330 decides to operate in a “non-still frame mode” or a “still frame mode” according to the self refresh enable signal SRE. If the compression rate of the original frame does not match a capacity of the buffer 350, the host 110 still maintains the self refresh enable signal SRE in a disable state such that the controller 330 operates in the “non-still frame mode”, even if the current original frame is a still frame. Meanwhile, the host 110 continues to transmit the display data D so as to transfer the original frame and subsequent original frames to the controller 330.

If the compression rate of the original frame matches the capacity of the buffer 350, the host 110 changes the state of the self refresh enable signal SRE to an enable state, and meanwhile, the host 110 stops the transmission of the display data D to the controller 330 upon transferring the original frame to the controller 330. The controller 330 enters the “still frame mode” according to the self refresh enable signal SRE. In the still frame mode, the controller 330 receives the original frame from the host 110, and then compresses the original frame to the buffer 350 through the compression/decompression unit 360. Next, the controller 330 dose not receive other original frames from the host 110 any more, but decompresses a compressed frame in the buffer 350 to obtain a decompressed frame through the compression/decompression unit 360, and controls the display module 140 to display the decompressed frame obtained from the buffer 350, until the state of the self refresh enable signal SRE is changed to the disable state such that the controller 330 switches to the “non-still frame mode”.

Table 1 is a comparison table of operating currents of FIGS. 1, 2, and 3. Referring to FIG. 1 and Table 1, it is assumed herein that a current required to transmit the display data D by the host 110 shown in FIG. 1 is 300 mA, and an operating current of the controller 130 is 60 mA, so a total operating current of the host 110 and the controller 130 is 360 mA.

TABLE 1
Comparison table of operating currents of FIGS. 1, 2, and 3.

| | Host | Controller | Sum | Power saving rate |
|---|---|---|---|---|
| FIG. 1 | 300 | 60 | 360 | 0% |
| FIG. 2 | 300 × 0.2 + | 60 × 0.2 + | 248 | 31.11% |
| | 80 × 0.8 | 140 × 0.8 | | |
| FIG. 3 | 300 × 0.36 + | 60 × 0.36 + | 238.4 | 33.78% |
| | 80 × 0.64 | 90 × 0.64 | | |

Referring to FIG. 2 and Table 1, if a number of “still frames” in the stream of the original frames accounts for 80% of a total number of the original frames, and an operating current of the host 110 shown in FIG. 2 for stopping the transmission of the display data D in the “still frame mode” is 80 mA, a total operating current of the host 110 shown in FIG. 2 is 300×(1−80%)+80×80%=124 mA. For the controller 230 shown in FIG. 2, if an operating current of the controller 230 and the frame buffer 250 in the “still frame mode” is 140 mA, a total operating current of the controller 230 is 60×(1−80%)+140×80%=124 mA. Therefore, a total operating current of the host 110, the controller 230, and the frame buffer 250 shown in FIG. 2 is 248 mA.

Referring to FIG. 3 and Table 1, if a number of “still frames” in the stream of the original frames accounts for 80% of a total number of the original frames, a number of “still frames” that can be successfully compressed to the buffer 350 in all the “still frames” accounts for 80% of the total number of the “still frames”, and an operating current of the host 110 shown in FIG. 2 for stopping the transmission of the display data D in the “still frame mode” is 80 mA, a total operating current of the host 110 shown in FIG. 3 is 300×(1−80%×80%)+80×80%×80%=159.2 mA. For the controller 330 shown in FIG. 3, if an operating current of the controller 330, the compression/decompression unit 360, and the buffer 350 in the “still frame mode” is 90 mA, a total operating current of the controller 330 is 60×(1−80%×80%)+90×80%×80%=79.2 mA. Therefore, a total operating current of the host 110, the controller 330, the buffer 350, and the compression/decompression unit 360 shown in FIG. 3 is 238.4 mA.

To sum up, when the display apparatus 320 performs self refresh, the transmission of the display data D between the controller 330 and the host 110 may be stopped, and thus the electronic system 300 and the display apparatus 320 according to this embodiment can lower power consumption. Compared with the embodiment shown in FIG. 2, the buffer 350 disposed in the display apparatus 320 in the embodiment shown in FIG. 3 has a capacity smaller than that of the frame buffer 250 in FIG. 2, thereby lowering the cost. As for the compression/decompression unit 360, though the compression/decompression unit 360 is shown outside the controller 330 and the buffer 350 in FIG. 3, the compression/decompression unit 360 may be embedded in the controller 330 or the buffer 350 to lower the cost in other embodiments. Taking the compression/decompression unit 360 embedded in the controller 330 as an example, the compression/decompression unit 360 may be implemented in the controller 330 by hardware, firmware, or software.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display controller, for controlling a display module, comprising:
a controller, receiving an original frame from a host, wherein the controller controls the display module to display the original frame provided by the host in a non-still frame mode;
a buffer; and
a compression/decompression unit, coupled between the buffer and the controller,
wherein the controller compresses the original frame to the buffer through the compression/decompression unit; and if the controller operates in a still frame mode, the controller decompresses a compressed frame in the buffer to obtain a decompressed frame through the compression/decompression unit, and controls the display module to display the decompressed frame.

2. The display controller according to claim 1, wherein the compression/decompression unit comprises:
a compressor, coupled between the buffer and the controller, wherein the compressor compresses the original frame provided by the controller into the compressed frame, and stores the compressed frame in the buffer; and
a decompressor, coupled between the buffer and the controller, wherein the decompressor decompresses the compressed frame provided by the buffer into the decompressed frame, and outputs the decompressed frame to the controller.

3. The display controller according to claim 1, wherein the controller decides to operate in the non-still frame mode or the still frame mode according to a self refresh enable signal of the host.

4. The display controller according to claim 1, wherein when the controller operates in the still frame mode, transmission of display data between the controller and the host is stopped after the compression/decompression unit successfully compresses the original frame to the buffer.

5. The display controller according to claim 1, wherein if the compression/decompression unit is incapable of compressing the original frame to the buffer, the controller ends the still frame mode and switches to the non-still frame mode, so as to receive a next original frame from the host.

6. The display controller according to claim 1, wherein a capacity of the buffer is smaller than a data volume of the original frame.

7. An operating method of a display controller, comprising:
receiving an original frame from a host;
compressing the original frame to obtain a compressed frame;
storing the compressed frame in a buffer;
in case of a non-still frame mode, controlling a display module to display the original frame provided by the host; and
in case of a still frame mode, decompressing the compressed frame to obtain a decompressed frame, and controlling the display module to display the decompressed frame.

8. The operating method of a display controller according to claim 7, wherein the display controller decides to operate in the non-still frame mode or the still frame mode according to a self refresh enable signal of the host.

9. The operating method of a display controller according to claim 7, further comprising:
stopping transmission of display data between the display controller and the host after the original frame is successfully compressed to the buffer, when the display controller operates in the still frame mode.

10. The operating method of a display controller according to claim 7, further comprising:
ending the still frame mode and switching to the non-still frame mode, so as to receive a next original frame from the host, if the display controller is incapable of compressing the original frame to the buffer.

11. A display apparatus, comprising:
a display module;
a controller, coupled to the display module, and receiving an original frame from a host, wherein the controller controls the display module to display the original frame provided by the host in a non-still frame mode;
a buffer; and
a compression/decompression unit, coupled between the buffer and the controller,
wherein the controller compresses the original frame to the buffer through the compression/decompression unit; and if the controller operates in a still frame mode, the controller decompresses a compressed frame in the buffer to obtain a decompressed frame through the compression/decompression unit, and controls the display module to display the decompressed frame.
